(19) United States
(12) Patent Application Publication
(10) Pub. No.: US 2011/0036320 A1
(43) Pub. Date: Feb. 17, 2011

(54) WASTE RECOVERY COGENERATOR

(75) Inventor: James Edward Peret, Boylston, MA (US)

Correspondence Address: CHOATE, HALL & STEWART LLP, TWO INTERNATIONAL PLACE, BOSTON, MA, 02110, US

(73) Assignee: University of Miami, Miami, FL (US)

(21) Appl. No.: 12/936,157

(22) PCT Filed: Apr. 3, 2009
(86) PCT No.: PCT/US09/39435

§ 371 Date: Oct. 29, 2010

Related U.S. Application Data
(60) Provisional application No. 61/042,488, filed on Apr. 4, 2008.
(60) Provisional application No. 61/042,497, filed on Apr. 4, 2008.

(51) Int. Cl. F01K 25/00; F02B 63/04; F01N 5/02; F02M 31/00

(52) U.S. Cl. 123/1 A; 123/3; 123/557; 60/320

(57) ABSTRACT

A waste-to-energy cogeneration system is described in various embodiments. The system can convert certain fuel-laden waste to thermal energy and electrical power. In certain embodiments, fuel-laden waste which has not been pre-filtered or pre-treated to remove particulates and water is deposited in the cogeneration system and prepared by the system for combustion in an unmodified diesel engine. The fuel-laden waste can comprise oils, greases and fats from food preparation which are contaminated with water and particulates. Thermal and mechanical energy produced by the engine are utilized to provide thermal energy and electrical power external to the cogeneration system.

### CROSS-REFERENCE TO RELATED U.S. APPLICATIONS

The present application claims priority to U.S. provisional patent application No. 61/042,497 filed on Apr. 4, 2008, and to U.S. provisional patent application No. 61/042,488 filed on Apr. 4, 2008, both of which are incorporated herein by reference.

### FIELD OF THE INVENTION

The invention relates to a system, apparatus and methods for recapturing energy from fuel-laden waste, e.g., used vegetable oil, grease, fat, wax, waste petroleum products, waste synthetic products. The invention more particularly pertains to cogeneration of heat and power from waste hydrocarbons.

### BACKGROUND

There have been recent advances in waste-to-energy conversion systems. Some systems utilize municipal solid waste containing hydrocarbon products, and convert the waste to energy using a large-scale facility, e.g., in a building-size or multi-structure facility. In some cases, a municipal solid waste stream is obtained at little or no cost. The waste stream may require sorting, and/or processing on a large scale before being used in a waste-to-energy conversion process.

Some large-scale waste-to-energy conversion systems rely on waste from a plurality of distributed sources. In some cases, the waste is retrieved from the distributed sources and transported to a waste processing facility, which may be remote from the site where the processed waste is converted to energy. The steps of transporting and processing the waste add expense to the overall waste-to-energy conversion process and can require a labor force.

Large scale waste-to-energy conversion systems can produce 500 kilowatts of electrical power or more, and may be connected to a local electrical power-distribution grid. The connection of a large scale conversion system to a local grid generally requires an interconnection device which synchronizes the waveform of the generated power with the waveform of the local distribution grid. The interconnection device allows large scale conversion system to add or provide electrical power to the grid, but such interconnection devices for large facilities can be large in size and expensive.

Conventional small-scale generator facilities generally utilize prime fuels such as gasoline, diesel, propane or natural gas. These fuels can be expensive, are not considered waste products, and their use depletes non-renewable natural reserves. Conventional small generator facilities generally are not adapted to utilize fuel-laden waste.

Information related to the technology of the present invention can be found in U.S. Pat. No. 5,264,121, entitled “Apparatus for purifying fuel,” issued Nov. 23, 1993; U.S. Pat. No. 6,071,420, entitled “Method and apparatus for separation of oil and water,” issued Jun. 6, 2000; U.S. Pat. No. 6,503,286, entitled “Fuel composition in the form of an emulsion derived from heterogeneous greasy waste and method for making same,” issued Jan. 7, 2003; U.S. Pat. No. 7,067,933, entitled “Waste oil electrical generation system,” issued Jun. 27, 2006; and U.S. Pat. No. 7,279,800, entitled “Waste oil electrical generation system,” issued Oct. 9, 2007, each of which is incorporated by reference herein in its entirety.

### SUMMARY

The present invention relates to a system useful for recapturing energy from certain waste products containing hydrocarbons in various forms. In various embodiments, the system comprises a cogeneration apparatus which converts sources of waste hydrocarbons into electricity and thermal energy, which are provided external to the cogeneration system. In certain embodiments, the system comprises a compact, turn-key, all-in-one waste-to-energy conversion system. The cogeneration system can be scaled and sized to the source of a fuel-laden waste stream, and can be located at the source of the waste stream.

In certain embodiments, the cogeneration system provides processing of fuel-laden waste, so that untreated and unfiltered waste can be deposited directly into the cogeneration system and utilized to produce electricity as well as heat. It will be appreciated that direct utilization of fuel-laden waste to produce electrical power and heat eliminates the need for separate processing of the waste products, e.g., processing waste at a separate facility or remote location. In various embodiments, thermal and electrical energy produced by the cogeneration system are provided to a facility, e.g., a commercial business, a residential dwelling, a maritime vessel, a train, a storage facility, an industrial facility, a warehouse, a mobile dwelling, a camp. In certain embodiments, the cogenerator is used to power a vehicle, e.g., a hybrid automobile, a maritime vessel, agricultural equipment, a truck, a bus, a train, etc.

In various embodiments, the waste-recovery cogeneration system comprises an internal combustion engine, an electrical generator powered by the internal combustion engine, an excess thermal energy system adapted to extract thermal energy produced by the internal combustion engine and provide excess thermal energy external to the system, and a fuel warming system adapted to extract thermal energy from engine combustion products and provide thermal energy to heat waste-recovered fuel within the cogeneration system. In various embodiments, the waste-recovered fuel is heated to a temperature such that water within the heated waste-recovered fuel is vaporized and can be separated from the fuel. In certain embodiments, the water vapor is vented from a tank or fuel heat exchanger containing the heated waste-recovered fuel and water vapor.

In various embodiments, the cogeneration system is adapted to receive and process raw fuel-laden waste for combustion in the system's engine. The fuel-laden waste utilized by the system can be unfiltered and untreated so as to remove particulates or water prior to depositing the fuel-laden waste in the cogeneration system. In various embodiments, several contaminants are removed from fuel-laden waste deposited in the cogeneration system. The cogeneration system can remove large and small particulates and water from the fuel-laden waste. In various embodiments, contaminants are removed from the fuel in an automated multistage process within the cogeneration system. The multistage process can comprise (1) removing large particulates, (2) heating the fuel, (3) removing water, and (4) removing small particulates. In various aspects, the automated fuel treatment conditions waste-recovered fuel for combustion in the system's engine.

In certain aspects, the cogeneration system provides for fuel-laden waste storage and removal, e.g., a dumpster. In some embodiments, the system's intake receptacle and tank comprise a dumpster for fuel-laden waste. As an example, fry oil waste from food preparation can be deposited directly from a fryer into the cogeneration system's intake receptacle and/or tank, and later utilized as waste-recovered fuel by the cogeneration system.

A variety of fuel-laden waste products can be utilized by the inventive system. In some embodiments, the waste-recovered fuel comprises vegetable oil from food preparation. In some embodiments, the waste-recovered fuel comprises fat or lard or grease that has been utilized in food preparation. In certain embodiments, the waste-recovered fuel comprises whole or party hydrogenated oil that has been utilized in food preparation. The waste-recovered fuel can comprise a petroleum or synthetic product that has been utilized in machine applications, e.g., engine lubrication, transmission lubrication, hydraulic power transmission, hydraulic lines, power steering, or machine cutting (cutting oils). The waste-recovered fuel can be a flammable gas such as propane, natural gas, hydrogen, carbon monoxide, or methane. In some embodiments, the waste-recovered fuel comprises virgin vegetable oil, virgin lard, virgin hydrogenated oil, biodiesel or petroleum diesel, fats, greases, waxes, or any combination thereof. In certain embodiments, fuel provided to the inventive system contains one or more contaminants, e.g., water, particulates, non-volatile polymers, char, and the like.

In various embodiments, the cogeneration system comprises an intake tank or fuel heat exchanger which utilizes thermal energy extracted from the engine combustion products by the fuel warming system to heat fuel within the intake tank or fuel heat exchanger. The heating of waste-recovered fuel can facilitate water removal and filtering. Additionally, the cogeneration system can heat the waste-recovered fuel to temperatures which promote combustion of the fuel in the system's internal combustion engine.

In certain embodiments, the cogeneration system provides internal self-cleaning of fuel supply lines. For example, fuel passageways within a fuel heat exchanger can be self-cleaned. The self-cleaning aspect can remove polymerized deposits of hydrocarbon waste products which may accumulate in fuel supply lines. Aspects of the self-cleaning can pass long-chain waxes, also useful waste products as a fuel source, through small-pore fuel filters and prevent their clogging the filters.

In certain embodiments, the cogeneration system includes a secondary fuel tank in which waste-recovered fuel can be heated to a desired operating temperature by a source of energy other than thermal energy from combustion products of the system's engine. The energy for heating fuel in the secondary tank can be derived from solar radiation, microwaves, electricity, or any combination thereof. In some embodiments, waste-recovered fuel from the secondary tank is circulated through a fluid circulation loop disposed with the system's internal combustion engine to heat certain engine components and promote combustion of waste-recovered fuel in the engine.

In certain embodiments, the inventive cogeneration system transforms organic solids into a fuel which is utilized by the system's internal combustion engine. In certain embodiments, a solids processor is provided with the system and utilizes gasification or pyrolysis to transform organic solids into a useable fuel. In some embodiments, the solids processor utilizes thermal energy from engine combustion products to transform solid organic compounds to liquid organic compounds.

The foregoing and other aspects, embodiments, and features of the present teachings can be more fully understood from the following description in conjunction with the accompanying drawings.

### BRIEF DESCRIPTION OF THE DRAWINGS

The skilled artisan will understand that the figures, described herein, are for illustration purposes only. It is to be understood that in some instances various aspects of the invention may be shown exaggerated or enlarged to facilitate an understanding of the invention. In the drawings, like reference characters generally refer to like features, functionally similar and/or structurally similar elements throughout the various figures. The drawings are not necessarily to scale, emphasis instead being placed upon illustrating the principles of the teachings. The drawings are not intended to limit the scope of the present teachings in any way.

FIG. 1 is a block-diagram representation of a waste-recovery cogeneration system.

FIG. 2 depicts an embodiment of apparatus for recovering energy from fuel-laden waste.

FIG. 3 depicts an embodiment of apparatus for recovering energy from fuel-laden waste.

The features and advantages of the present invention will become more apparent from the detailed description set forth below when taken in conjunction with the drawings.

### DEFINITIONS

fuel-laden waste—This term refers to any waste material in solid, semi-solid, or liquid form containing hydrocarbons which can be processed by the cogeneration system to recover a combustible fuel utilized by the system's engine. Fuel-laden waste is deposited in the system's intake tank or intake receptacle.

waste-recovered fuel—This term is used to refer to partially processed or fully processed fuel-laden waste within the cogeneration system.

### DETAILED DESCRIPTION

### System Overview

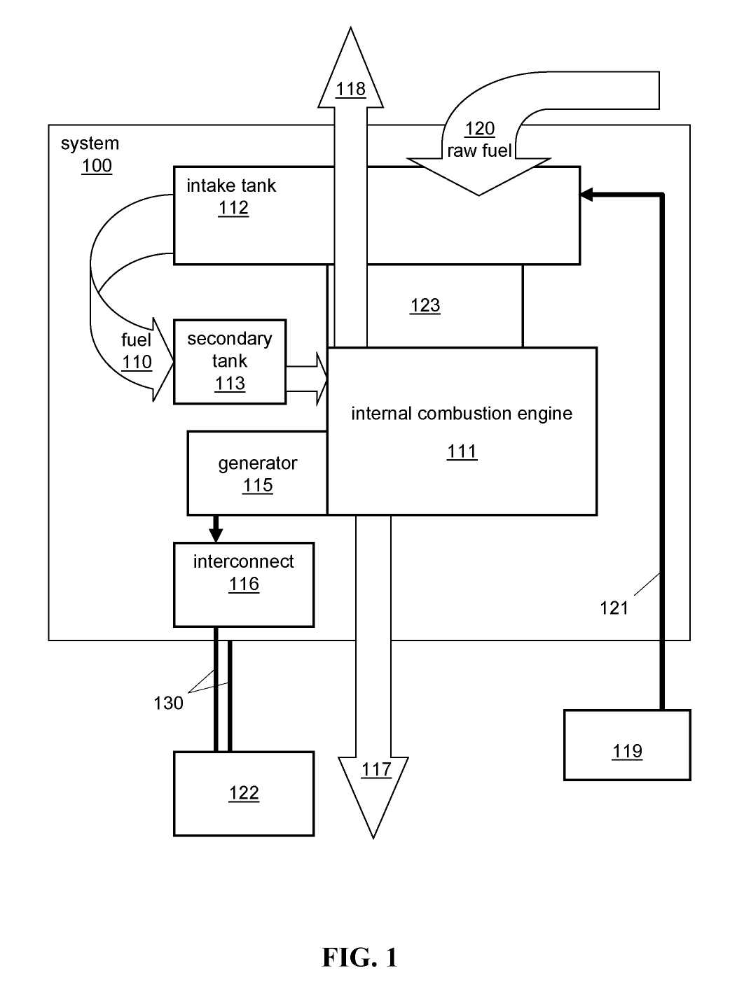

In overview and referring now to FIG. 1, in various embodiments, the waste-recovery cogeneration system 100 comprises a combined heat and power (CHP) system. In certain embodiments, the system 100 comprises a waste-recovered-fuel intake tank 112, a secondary tank 113, an internal combustion engine 111, a generator 115, and an electrical power interconnect device 116. In certain embodiments, an excess thermal energy system 117 is provided with the system 100. In various embodiments, an exhaust system 118 transports high-temperature combustion products from the system's engine 111. In certain embodiments, the cogeneration system 100 includes a transport line 121 and apparatus 119 for automated secondary fuel acquisition. In some embodiments, apparatus 119 comprises a grease interceptor, or grease trap. Raw fuel-laden waste 120 can be provided to intake tank 112. In certain embodiments, partly processed waste-recovered fuel 110 is provided to secondary tank 113 and then to engine 111 for combustion. In some embodiments, the system includes a solids processing unit 123. In certain embodiments, the system 100 is electrically connected to a facility 122 through one or more electrical lines 130. Electrical power or current can be provided from the system 100 to the facility 122 through a line 130. In some embodiments, electrical power or current can be drawn by the system 100 from the facility 122 through a line 130.

In operation, raw fuel-laden waste 120 can be manually or automatically provided to the intake tank 112. In some embodiments, the intake tank 112 is adapted to heat waste-recovered fuel within the tank to a desired operating temperature using thermal energy provided from the exhaust system 118. In certain embodiments, the waste-recovered fuel within the intake tank 112 is heated to a temperature between about 212° F. and about 275° F. The elevated temperature partly prepares the raw fuel 120 for combustion in the system's engine 111. Heating of the raw fuel facilitates removal of contaminants within the fuel, e.g., removing large and small particulates via filtering, removing water via evaporation. In various embodiments, water vapor is removed, e.g., via venting, from the intake tank 112. In certain embodiments, processed waste-recovered fuel 110 flows into a secondary tank 113, which is maintained at a desired temperature to promote combustion of the fuel in the system's engine 111. In certain embodiments, the waste-recovered fuel in the secondary tank 113 is maintained at a temperature in a range between about 150° F. and about 275° F. In certain embodiments, fuel in the secondary tank is heated by energy provided from a source external to the system 100. In some embodiments, energy from either or both an external source and an internal source are used to heat fuel in the secondary tank 113. In various embodiments, waste-recovered fuel from the secondary tank 113 is provided to power the internal combustion engine 111. The internal combustion engine 111 combusts the fuel to produce mechanical energy as well as thermal energy. Mechanical energy, e.g., rotary motion, can be used to power the electrical generator 115 and produce electricity. Thermal energy, e.g., thermal energy derived from high-temperature combustion products, can be extracted by excess thermal energy system 117 and provided external to the system 100, as well as utilized within the system 100 to prepare the raw fuel-laden waste 120 for combustion.

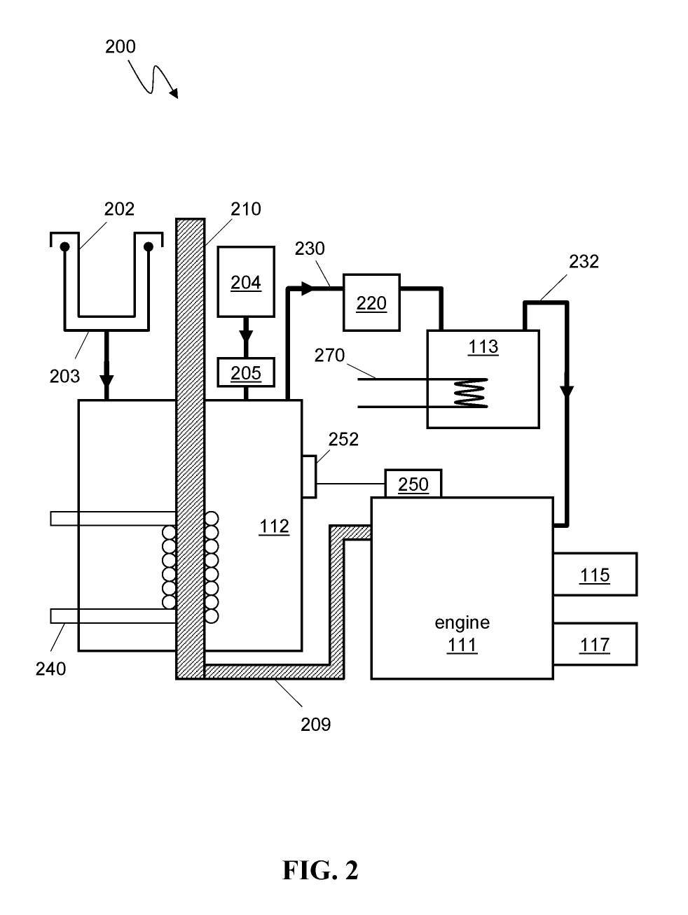

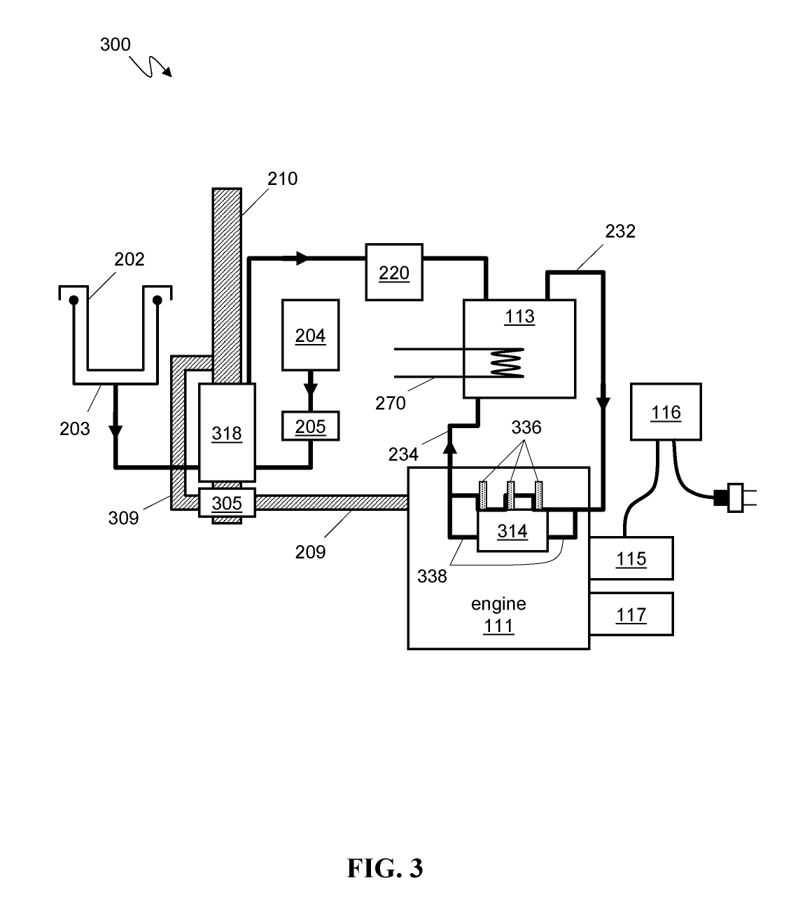

Two embodiments of waste-recovery cogeneration systems are depicted in FIGS. 2-3. For the embodiment depicted in FIG. 2, the system 200 comprises a waste-recovered-fuel intake tank 112, a secondary tank 113, an internal combustion engine 111, a generator 115, and an excess thermal energy system 117. In various embodiments, an intake receptacle 203 with coarse filter 202 receives raw fuel-laden waste, and provides coarse-filtered waste-recovered fuel to intake tank 112. Exhaust carrying high-temperature combustion products from the engine 111, can be directed through an exhaust pipe 209, which is connected to a fuel-warming system 210. In certain embodiments, a thermal exchange circuit 240 is disposed within tank 112. The tank 112 can be further adapted to receive waste-recovered fuel from a secondary source 204, e.g., a source of grease, fats, or waxes. Waste-recovered fuel from the secondary source 204 can be admitted into the tank through control valve 205. A coarse filter can be provided with the secondary source 204 or the control valve 205 to remove large particulates from fuel-laden waste of the secondary source. In certain embodiments (not depicted), the fuel-warming system 210 provides heat to the receptacle 203 and/or the secondary source 204. The provided heat can render solidified fats, greases or waxes into a liquid state, and can decrease the viscosity of a liquid fuel-laden waste. The decreased viscosity can facilitate filtering of the waste.

In various embodiments, intake tank 112 is adapted to provide heated and coarse-filtered fuel through fuel line 230 to the secondary tank 113. A fine fuel filter 220 can be disposed between intake tank 111 and secondary tank 113 and used to remove small particulates from the heated waste-recovered fuel. The secondary tank 113 can incorporate a heating element 270 or otherwise be adapted to heat fuel within the tank to temperatures which promote combustion of the fuel in engine 111. In various embodiments, heated and fine-filtered waste-recovered fuel is provided through fuel line 232 to a fuel intake system of engine 111.

In certain embodiments, the cogeneration system includes electronics adapted to automate operation of the cogeneration system. In certain embodiments, the electronics comprise a processor 250 and one or more sensors 252. Sensors 252 can be disposed to monitor temperature of heated fuel in one or more places within the system, an undesirable presence of exhaust fumes, electrical power output, excess thermal heat output, the quantity of fuel in the intake tank 112, the quantity of fuel in the secondary tank 113, engine operating speed, total engine operating hours, or any combination thereof.

For the embodiment depicted in FIG. 3, the system 300 comprises a waste-recovered-fuel heat exchanger 318, a secondary tank 113, an internal combustion engine 111, a generator 115, an excess thermal energy system 117, and an electrical power interconnect device 116. For an embodiment as depicted in FIG. 3, the size of the intake receptacle 203 is larger than would be the case for an embodiment as depicted in FIG. 2. The intake receptacle 203 can be sized to receive and store an amount of fuel-laden waste produced by a source in a selected period of time, e.g., a 6-hour period, a 12-hour period, an 18-hour period, a 24-hour period, a 2-day period, a 4-day period, and yet a 7-day period. In certain embodiments, the system includes an exhaust by-pass 309, which can divert high-temperature combustion products from the engine 111 around the fuel heat exchanger 318. An exhaust control valve 305 can be operated by a system controller or processor 250 to regulate temperature of fuel within the fuel heat exchanger 318 by diverting around or admitting into the heat exchanger high-temperature combustion products. In some embodiments, the secondary tank 113 is adapted to provide heated fuel recirculation through the engine 111 via feed fuel line 232 and return fuel line 234. These lines can connect to a fluid circulation circuit 338 which elevates the temperature of certain engine components, e.g., engine block, high-pressure fuel pump 314, high-pressure fuel lines 336, to promote combustion of waste-recovered fuel in the engine's cylinders.

It will be appreciated that certain elements depicted in FIGS. 2-3 can be removed from the system or used in the other depicted embodiment. For example, the secondary source 204 and control valve 205 can be removed from the system. As an additional example, the thermal exchange circuit 240 can be added to the fuel heat-exchanger 318. In some embodiments, excess thermal heat from the thermal exchange circuit 240 can supplement output provided by the excess thermal heat system 117. As an additional example, an exhaust bypass 309 can be added to the embodiment depicted in FIG. 2. As an additional example, the secondary tank's recirculation system for warming engine components can be added to the embodiment depicted in FIG. 2. Additional configurations will be appreciated by one skilled in the art.

In certain embodiments, the cogeneration system is sized to substantially match its fuel consumption rate to the rate of production of fuel-laden waste by the source of fuel-laden waste over a selected period of time. For example, a source of fuel-laden waste can produce, on average, an amount of fuel-laden waste over a 24-hour period, and the system can be sized to process and combust the average amount of fuel-laden waste over a period of time less than 24 hours, for example a five- to ten-hour period during non-noise-sensitive hours. The system can further include storage tanks to accumulate waste-recovered fuel during noise-sensitive hours and during above-average production periods. Tank reserve capacity can provide for variations in the rate of production of fuel-laden waste around the average value. Engine and electrical generator sizes can be selected to obtain a desired fuel consumption rate. The desired consumption rate can be greater than the rate of generation of fuel-laden waste to allow for sustained overproduction periods.

In certain embodiments, the cogeneration system is compact. For example, the embodiments depicted in FIGS. 2-3 comprise a system measuring about six feet in height, about two feet in depth, and about six feet in width. In some embodiments, the dimensions of the cogeneration system are less than these values. In some embodiments, the dimensions of the cogeneration system are greater than these values.

In various embodiments, the inventive waste-recovery cogenerator provides efficient, reliable, easy-to-operate, economically feasible, small-scale production of electrical power. The inventive system can provide automated processing and use of untreated and unfiltered fuel-laden waste, in liquid, semi-liquid, and/or solid form, for electricity generation. An advantage of the system is its ability to additionally provide excess thermal energy for general heating purposes, e.g., heating domestic hot water or air. Further aspects of the inventive cogeneration system 100 are described in the following sections.

### Intake Tank/Fuel Heat Exchanger

In various embodiments, the cogeneration system's intake tank 112 or heat exchanger 318 are adapted to heat waste-recovered fuel by utilizing thermal energy from high-temperature combustion products from the system's internal combustion engine 111. In certain embodiments, the cogeneration system's intake tank 112 or heat exchanger 318 are adapted to remove water contaminants from the waste-recovered fuel. In certain embodiments, the heat exchanger 318 holds a volume of waste-recovered fuel which is smaller than the volume of intake tank 112.

In various embodiments, the temperature of the waste-recovered fuel within the intake tank 112 or heat exchanger 318 is raised above the boiling point of water, although any additional rise in temperature can increase the water evaporation rate. By elevating the temperature of the waste-recovered fuel, any moisture contamination can be converted to vapor and separated from the fuel. In certain embodiments, fuel types with low volatility, e.g., vegetable oil, will not evaporate, and accumulated vapor in the tank can be vented to the atmosphere. The tank 112 or heat exchanger 318 can incorporate a vent to vent evaporated water from the waste-recovered fuel out of the tank 112 or heat exchanger 318. In some embodiments, accumulated vapors are vented to the intake manifold of the combustion engine, so that vapors from more volatile fuels are combusted in the engine. In some embodiments, the tank works particularly well with low volatility fuels such as vegetable oil.

In various embodiments, high-temperature combustion products from the system's engine 111 are routed through the intake tank 112 or heat exchanger 318 and provide heat to the waste-recovered fuel therein. The combustion products can pass through the fuel-warming system 210, which can be located adjacent to or within the intake tank or heat exchanger. The fuel-warming system can extract thermal energy from the combustion products and provide thermal energy to the waste-recovered fuel. In certain aspects, the combustion/heating cycle is self-sustaining. Heated fuel for subsequent combustion cycles derives its heat from combustion products of preceding combustion cycles. In certain aspects, the exhaust gases from the engine in the inventive cogeneration system are cooled by the waste-recovered fuel. This can eliminate the need for an additional water or gaseous cooling system to cool the exhaust gases, as might be used in other systems.

In various embodiments, a fuel-warming system 210 is in thermal communication with waste-recovered fuel inside the tank 112 or heat exchanger 318. The fuel-warming system 210 can be an integral part of the heat exchanger 318. In various embodiments, the fuel-warming system 210 passes high-temperature combustion products from the cogeneration system's engine 111 and captures a portion of thermal energy from the passed combustion products. The captured thermal energy is provided by the fuel-warming system 210 to heat waste-recovered fuel. In certain embodiments, the fuel-warming system 210 includes an exhaust by-pass 309 which diverts at least a portion of the high-temperature engine combustion products around the intake tank 112 or heat exchanger 318. In some embodiments, apparatus connected to the exhaust by-pass is adapted to divert all of the high-temperature engine combustion products around the intake tank 112 or heat exchanger 318 in response to a control command.

The fuel-warming system 210 can comprise a single pipe or multiple-pipe apparatus passing through tank 112 or heat exchanger 318 in thermal communication with waste-recovered fuel inside the tank or exchanger. In some embodiments, the fuel-warming system 210 includes heat dissipating fins in thermal contact with fuel in the tank 112 or heat exchanger 318. In certain embodiments, the fuel-warming system 210 comprises an inner cylinder, which carries high-temperature combustion products, surrounded by an outer cylinder. The outer cylinder can be in contact with waste-recovered fuel. In various embodiments, waste-recovered fuel is excluded from the region between the inner and outer cylinders. The two cylinders can be connected by radial fins, which also convey heat to the outer cylinder. A breach of the inner cylinder can be detected by a sensor which samples air provided from the region between the cylinders. Such a dual cylinder design can provide for safe heating of waste-recovered fuel without the risk of igniting heated fuel upon a breach of the fuel-warming system 210.

In certain embodiments, the intake tank 112 includes an integrated fuel filtration system. The fuel filtration system can be disposed within the intake tank 112 or at the tank's intake receptacle 203 as depicted in FIG. 2. In some embodiments, the intake receptacle 203 can be incorporated within a portion of the intake tank 112, e.g., a separate chamber within the tank or attached directly to the tank. For the embodiment depicted in FIG. 3, the intake receptacle 203 can comprise a receiving tank for the system. In various embodiments, the intake tank 112 or intake receptacle 203 are adapted to receive fuel-laden waste, e.g., used vegetable oil, olive oil, cooking oils, which may be contaminated with water and/or particulates. The volume of the intake tank or receptacle can be any value between about one gallon and about 200 gallons. In various embodiments, the intake tank 112 or intake receptacle 203 comprises a dumpster for fuel-laden waste.

In various embodiments, the intake receptacle 203 comprises a large orifice to enable rapid transfer of large quantities of fuel-laden waste, e.g., transferring about five gallons of used cooking oil in less than about two minutes. A coarse or large pore filter can be disposed in the receptacle to remove large particulates from the fuel-laden waste. In various embodiments, a cover is provided with the intake receptacle 203 to prevent the introduction of large amounts of rainwater into the receptacle.

In some embodiments, the intake tank 112 or heat exchanger 318 includes a secondary heat-control apparatus to maintain operating temperature of the waste-recovered fuel. The secondary heat-control apparatus can be an electrically-powered heating element, or a thermal heat exchange circuit 240. The heat exchange circuit 240 can comprise a water or fluid circulation loop. In some embodiments, domestic hot water flows through the heat exchange circuit 240. In some embodiments, a fluid coolant flows through the heat exchange circuit 240. The flow rate of the water or fluid can be controlled to regulate the temperature of fuel within the tank 112 or heat exchanger 318. In some embodiments, the maximum temperature of waste-recovered fuel within the intake tank 112 or heat exchanger 318 is limited by locating the intake tank 112 or heat exchanger 318 and fuel-warming system 210 a specified distance downstream on the engine's exhaust system. The location of the tank or exchanger and fuel-warming system can depend upon a number of factors including the volume of fuel to be heated, the size of the engine 111, the thermal conductivity between the flow of combustion products from the engine and the fuel, and the thermal conductivity between the intake tank 112 or heat exchanger 318 and ambient environment. In certain embodiments, the temperature of waste-recovered fuel is maintained and limited by a combination of heat exchange circuit 240, location of tank or exchanger and fuel-warming system, and exhaust bypass.

Although the heat exchange circuit 240 is depicted in FIG. 2 as being in contact with the fuel-warming system 210 within the intake tank 112, in some embodiments the heat exchange circuit 240 is not in contact with the fuel-warming system. The heat exchange circuit 240 can surround the fuel-warming system with an intervening region between the heat exchange circuit 240 and the fuel-warming system 210. In some embodiments, the heat exchange circuit does not surround the fuel-warming system. In some embodiments, the heat exchange circuit is located in a region within the intake tank 112 away from the heat exchange circuit 240. In some embodiments, the heat exchange circuit 240 is located outside the intake tank 112 or heat exchanger 318, e.g., on a section of the fuel-warming system 210 or exhaust 209 prior to the tank or exchanger.

In certain embodiments, a secondary fuel collector 204 and control valve 205 are connected to the intake tank 112 or heat exchanger 318. The collector 204 can harvest fuel-laden waste from a second source. In some embodiments, the secondary fuel collector 204 collects grease from a food preparation grease trap. The grease can be admitted into the intake tank 112 or heat exchanger 318 by control valve 205.

In some embodiments, the intake tank 112 or heat exchanger 318 include an evaporative air space connected to a vent (not depicted) which can vent vaporized water from the tank or exchanger. In some embodiments, the intake tank 112 or heat exchanger 318 include an evaporative air space connected to a vacuum pump. The vacuum pump can be used to decrease pressure within the air space, which can increase the water evaporation rate from the waste-recovered fuel. In certain embodiments, substantially all water is removed from waste-recovered fuel provided from the intake tank 112 or heat exchanger 318.

In certain embodiments, the fuel heat exchanger 318 is in thermal communication with the fuel-warming system 210. In certain embodiments, the fuel heat exchanger is integrated with the fuel-warming system. In various embodiments, the fuel heat exchanger 318 comprises a heat exchange unit which provides thermal communication between an amount of flowing waste-recovered fuel inside the exchanger and at least a portion of the fuel-warming system 210, or portion of the exhaust system from the internal combustion engine. In some embodiments, the thermal communication is direct, i.e., the waste-recovered fuel is in thermal contact with an element of the fuel-warming system or exhaust system, which are heated by engine combustion products. In some embodiments, the thermal communication is indirect, i.e., the waste-recovered fuel is in thermal contact with a secondary element, which is heated directly or indirectly by an element of the fuel-warming system 210 or engine's exhaust system. In various aspects, the residence time of the amount of waste-recovered fuel flowing through the fuel heat exchanger is controlled such that water within the amount of fuel boils or vaporizes. In certain embodiments, the amount of fuel flowing through the fuel heat exchanger reaches a temperature between about 212° F. and about 275° F.

For purposes of understanding, the amount of fuel flowing through the fuel heat exchanger can be considered as a “plug” of fuel passing through the heat exchanger 318. The stream of fuel flowing through the fuel heat exchanger can be considered as a sequence of plugs. As a plug traverses the heat exchanger, its temperature rises. In various embodiments, the temperature reaches a maximum value approximately at the time the amount of fuel exits the heat exchanger.

In various embodiments, the heat exchanger 318 of the inventive cogeneration system is self-cleaning and prevents clogging of the system's fine fuel filter 220 with combustible long chain waxes or polymers. The heat exchanger 318 can provide for self-cleaning and removal of waste-recovered-fuel polymers which might otherwise deposit on fuel passageways within the heat exchanger and clog the passageways. In various embodiments, the heat exchanger 318 is operated at a temperature and pressure such that substantially all water within an amount of waste-recovered fuel within the exchanger 318 boils before the amount exits the heat exchanger. The vaporized water can be collected in a steam trap and vented from the exchanger. In some embodiments, the vented gas is provided to the air intake manifold of the system's engine 111 to combust any volatile components in the vented gas. In some embodiments, the vented gas is cooled to condense and remove an amount of water from the gas before the gas is provided to the engine's intake manifold.

In certain embodiments, the heat exchanger 318 is operated at a temperature and pressure such that water within waste-recovered fuel inside the exchanger boils explosively upon contact with internal surfaces of passageways within the heat exchanger 318. The explosive boiling can remove fuel-derived polymers which may have deposited on the passageways. In various embodiments, the aggressive removal of water within the heat exchanger 318 self-cleans the internal fuel passageways.

In some embodiments, the heat exchanger 318 is operated at a temperature and pressure such that combustible long chain waxes or polymers within the fuel pass through the system's fine or small pore filter 220 disposed in a fuel line running from the fuel heat exchanger. By increasing the pressure within the heat exchanger 318, the temperature of the waste-recovered fuel can be increased since the boiling points for both water and fuel products are elevated. At higher temperatures, certain combustible long chain waxes within the waste-recovered fuel can pass through the system's small pore filter and be provided for combustion in the system's engine. At lower temperatures, these long chain waxes would clog the small pore filter, disrupt the fuel supply, and themselves be lost as a useable fuel.

In certain embodiments, the temperature of an amount of waste-recovered fuel within the heat exchanger 318 is between about 212° F. and about 275° F. In certain embodiments, the pressure as measured in an evaporative air space connected to the heat exchanger 318 is between about 10 PSIG and about 150 PSIG. In some embodiments, the exhaust bypass 309 is adapted to divert engine exhaust around the fuel heat exchanger 318 so as to maintain the temperature of waste-recovered fuel exiting the heat exchanger between about 212° F. and about 275° F.

In certain embodiments, the temperature of at least a portion of waste-recovered fuel within the intake tank 112 is between about 212° F. and about 275° F. In certain embodiments, the pressure as measured in an evaporative air space connected to the intake tank 112 is between about −5 PSIG and about +50 PSIG.

It will be appreciated that the intake tank 112 or heat exchanger 318 can be operated under pressure or under vacuum. The application of vacuum can permit a reduction in temperature of the waste-recovered fuel, e.g., to values between about 150° F. and about 212° F. At these lower temperatures, water can still be evaporated from the fuel with the application of vacuum pressure. In certain embodiments, the fuel heat exchanger 318 or intake tank 112 is operated under reduced pressure, e.g., a pressure between about −5 PSIG and about 0 PSIG, to promote water removal at temperatures less than about 212° F., e.g., temperatures between about 150° F. and about 212° F. Conversely, at higher applied pressures, it may be necessary to heat the waste-recovered fuel to temperatures about 275° F.

### Engine

In various embodiments, the internal combustion engine 111 comprises an unmodified diesel engine. The engine can be a two-cylinder diesel engine, a three-cylinder diesel engine, a four-cylinder diesel engine, a six-cylinder diesel engine, an eight-cylinder diesel engine, a ten-cylinder diesel engine, a 12 cylinder diesel engine, and yet an 18 cylinder diesel engine in certain embodiments. The engine can be liquid cooled, e.g., cooled with water, or engine coolant, or the engine can be air cooled. The engine 111 can include an electric starter motor which can be powered by a battery or by electrical current provided through electrical line 130 from a source external to the system 100. In certain embodiments, the engine includes an integrated starter/generator which can both assist in starting the engine and converting mechanical energy provided by the running engine into electricity.

In certain embodiments, the engine 111 incorporates a heated-fuel circulation circuit disposed to provide heat to or extract heat from certain engine components, e.g., the engine block, the high-pressure fuel pump 314 which provides pressurized fuel to the cylinder injectors, high-pressure fuel lines 336 which transport fuel from the pump 314 to the engine cylinders. In certain embodiments, the heated-fuel circulation circuit provides heat to the engine components prior to starting the engine. This can promote combustion of waste-recovered fuel in the engine. After the engine has been started, the heated-fuel circulation circuit can be stopped, or it can be used to extract heat from the engine components and heat fuel in the secondary tank 113. This can permit termination of heating provided by element 270 in the secondary tank.

### Electricity Generation

In certain embodiments, the system's engine 111 powers electrical generator 115 to produce electricity which can be supplied to users external to the system 100. In certain aspects, the cogeneration system is operated as a small generator to provide either backup, emergency power, or prime power to a facility. When operated in an emergency or back-up manner, e.g., providing “island” power, the system may not require an interconnection device 116 to synchronize produced electrical power with a local electrical power distribution grid.

In some embodiments, the cogeneration system includes an interconnect device 116 to synchronize produced electrical power with a local electrical power distribution grid. The interconnect device 116 can be an inverter. In certain embodiments, the generator 115 comprises an alternator which outputs alternating voltage and current waveforms. Output from the alternator can be conditioned and synchronized by the inverter so that the conditioned and synchronized waveform can be provided to a local electrical power distribution grid. In various embodiments, the inverter permits the engine to run at an operating speed, e.g., a selected RPM, which is independent from the cyclical frequency of the local electrical power distribution grid. The use of the inverter can provide for operation of the system's engine 111 at a desirable operating point, e.g., an operating point comprising reduced fuel consumption, increased energy-conversion efficiency, reduced noise, or any combination thereof. In some embodiments, the cogeneration system includes a synchronous generator or an inductive generator adapted to provide interconnection to a local electrical power distribution grid. The synchronous generator or inductive generator can synchronize produced electrical power with electrical power on a local electrical power distribution grid.

In various embodiments, electricity produced by the generator 115 is provided, in conditioned or non-conditioned form, to a facility 122 external to the system. The facility can comprise a commercial business, a residential dwelling, a vehicle, a maritime vessel, a train, a storage facility, an industrial facility, a warehouse, a mobile dwelling, or a camp. In some embodiments, the generator 115 provides electrical current, in conditioned or non-conditioned form, to charge an electrical storage device, e.g., a battery, a plurality of batteries, a capacitor, a plurality of capacitors.

### Vehicle Power

It will be appreciated that the waste-recovery cogeneration system can be utilized to power a mobile vehicle. In certain embodiments, the system's engine 111 provides power to the drive train of a vehicle. In some embodiments, the cogeneration system is adapted to function as the power plant for a hybrid diesel/electric vehicle. For example, the engine 111 can provide mechanical power to the drive train of the hybrid vehicle, provide heat energy to power a fuel reformation process, as well as provide power to operate the generator 115 which can be adapted to charge the hybrid vehicle's on-board battery or charge storage device. In certain embodiments, the hybrid vehicle provides an electrical interconnect for connecting the cogeneration system to an external supply of electrical power. The external supply of power can be used to heat fuel in the secondary tank 113 and/or charge the vehicle's on-board battery or charge storage device.

### Excess Thermal Energy

In various embodiments, the cogeneration system 100 includes an excess thermal energy system 117. In various embodiments, the excess thermal energy system 117 diverts excess thermal energy out of the cogeneration system for use in an external facility. As an example, excess thermal energy produced by the system can be provided to heat domestic hot water for a commercial business, a residential dwelling, a maritime vessel, a train, a storage facility, an industrial facility, a warehouse, a mobile dwelling, or a camp. As another example, excess thermal energy produced by the system can be provided to heat another fluid or air used within a facility. In some embodiments, water from a domestic hot water system of a facility is circulated through the cogeneration system to extract heat from the cogeneration system and heat the circulating water. In some embodiments, the circulating water passes through a heat exchange loop, e.g., loop 240, within the system. In some embodiments, the circulating water extracts thermal energy via a heat exchange loop used to cool the cogeneration system's engine 111. In some embodiments, air from the facility is circulated through the cogeneration system and extracts thermal energy from a heat exchange loop used to cool the cogeneration system's engine 111. In various embodiments, the excess thermal energy system 117 comprises a fluid or air heat-exchange circuit disposed within the cogeneration system and adapted to extract thermal energy from one or more components within the cogeneration system.

### Four-Stage Processing of Fuel

In certain aspects, the inventive waste-recovery cogeneration system includes a four-stage waste-recovered fuel processing system. Waste vegetable oil cannot be used directly in an unmodified diesel engine, because it contains particulates and immiscible liquids such as water. Additionally, waste vegetable oil at room temperature is too viscous to be used in a diesel engine. However, a diesel internal combustion engine can run on clean vegetable oil if the oil temperature is elevated such that the viscosity of the heated oil is about the same value as that of standard diesel fuel. Although mechanical filtration can remove particulate impurities, water contamination cannot be removed with filtration. In various embodiments, the inventive cogeneration system provides four stages of waste-recovered fuel treatment comprising (1) removing large particulates from fuel-laden waste with a large-pore filter, (2) elevating the temperature of the waste-recovered fuel, (3) evaporating water from the waste-recovered fuel at elevated temperatures, and (4) removing small particulates from the waste-recovered fuel with a small-pore filter at elevated temperatures. Further, the waste-recovered fuel provided to the system's engine can be maintained at a high temperature to reduce its viscosity and promote combustion in the engine. In this manner, the inventive cogeneration system utilizes fuel-laden waste which is too contaminated for use in a diesel engine, or not appropriate for combustion under normal ambient thermal conditions. In various embodiments, the four-stage fuel-treatment process eliminates the need for external or remote processing of fuel-laden waste, e.g., pre-filtering or pre-treatment to remove water.

In certain embodiments, the four-stage fuel-treatment process can be run substantially continuously. The large-pore filter can be disposed at the intake of the fuel system, so that it can be exchanged while the system is running The small-pore filter can be exchanged at widely spaced maintenance intervals, e.g., 3-month maintenance service, 6-month maintenance service, or 1-year maintenance service. In some embodiments, the small-pore filter can be provided with a by-pass loop so that the filter can be exchanged while the system is in operation. In certain embodiments, the system provides for interruption of the fuel-treatment process for filter replacement without disruption to the power generation aspect of the system.

### Fuel Filtering

In certain embodiments, mechanical filtration of waste-recovered fuel is realized in two separate places within the cogeneration system. A large-pore filter 202 can be disposed at a fuel-laden waste intake receptacle 203. The large-pore filter can substantially prevent passage of large particulates into the intake tank 112 or the fuel heat exchanger 318. In certain embodiments, the large-pore filter has pore sizes of values between about 800 microns and about 1000 microns. The pore sizes can be clustered narrowly about any value within this range, e.g., having an average pore size of 850 microns with a distribution of about ±40 microns. In various embodiments, the large pore filter is easily accessed for replacement.

A second fine-pore filter 220 can be disposed within the cogeneration system such that an amount of heat generated by the engine 111 or engine exhaust system impinges on the filter to facilitate fuel flow through the filter. In various embodiments, the small-pore filter 220 substantially prevents small particulates that would damage engine components from flowing to the engine 111. In some embodiments, the small-pore filter 220 is located inside or on the intake tank 112, or in close proximity to the intake tank. In some embodiments, the small-pore filter 220 is located inside or on the secondary tank 113, or in close proximity to the secondary tank. In some embodiments, the small-pore filter 220 is located on or in close proximity to the fuel heat exchanger 318. In some embodiments, the small-pore filter 220 is located on or in close proximity to the engine's exhaust system or the fuel warming system 210. In certain embodiments, the small pore filter has pore sizes of values between about 2 microns and about 200 microns. The pore sizes can be clustered narrowly about any value within this range, e.g., having an average pore size of 50 microns with a distribution of about ±3 microns. In certain embodiments, the fine-pore filter 220 is installed in a manner to allow replacement without interrupting fuel flow to the engine 111.

In certain embodiments, the pore sizes of filters are selected based upon the distribution of particle sizes within the fuel-laden waste or waste-recovered fuel.

### Secondary Tank/Engine Heating

In certain embodiments, a secondary fuel tank 113 maintains waste-recovered fuel therein at an elevated temperature to promote combustion of the fuel in the engine. The elevated temperature can be maintained by a secondary energy source external to the cogeneration system. In some embodiments, the secondary source is derived from a local electrical power distribution grid and heat is provided to the fuel within the secondary tank 113 by a heating apparatus, e.g., an electrical resistance heater 270. In some embodiments, the secondary source of energy comprises solar radiation, microwave radiation, electricity or any combination thereof. The volume of fuel in the secondary tank 113 can be any value between about one gallon and about twenty gallons. Heating of the small amount of waste-recovered fuel contained in the secondary tank 113 by a secondary power source can reducing the delay between electrical powering up of the cogeneration system and starting the system's engine 111 to produce excess thermal heat and electrical power. It will be appreciated that heating of waste-recovered fuel in the secondary tank 113 can enable starting of the cogeneration system's engine without the need to heat a larger bulk of fuel in the system's intake tank 112, or intake receptacle 203.

In various embodiments, waste-recovered fuel that has been heated in the intake tank 112 or fuel heat exchanger 318 is fed to the secondary tank. In certain embodiments, the waste-recovered fuel is brought to a desired temperature to promote combustion in the secondary tank 113, and then fed to an unmodified diesel internal combustion engine 111.

In some embodiments, the intake tank 112 or fuel heat exchanger 318 incorporates a heating apparatus, e.g., an electric resistance heater, powered by a source external to the cogeneration system. In some embodiments, the fuel feed line 232 to the internal combustion engine 111 incorporates a heating apparatus, e.g., an electric resistance heater, powered by a source external to the cogeneration system. In some embodiments, at least a portion of the secondary fuel tank 113 physically resides within the intake tank 112.

In certain embodiments, the secondary fuel tank 113 is adapted to provide heated fuel to a fluid circulation circuit 338 disposed with the internal combustion engine 111, as depicted in FIG. 3. The fluid circulation circuit can provide heated fuel to the engine to elevate the temperature of engine components. This can promote combustion of waste-recovered fuel in the engine. In some embodiments, the fluid circulation circuit provides heat to the engine block, a high-pressure fuel pump 314 providing pressurized waste-recovered fuel to the engine cylinders, high-pressure fuel lines 336 running to the engine cylinders, or any combination thereof.

In certain embodiments, after the engine has been started, circulation of fuel in the fluid circulation circuit can be stopped, or it can be used to extract heat from the engine components and heat fuel in the secondary tank 113. This can permit termination of heating provided by element 270 in the secondary tank.

### Fuel Types

Various types of fuel-laden waste can be utilized by the cogeneration system. In various aspects the fuel-laden waste contains particulate contaminants and/or water. In some embodiments, fuel-laden solid waste can be utilized by the cogeneration system. In some embodiments, certain gases can be combusted by the system's engine. In certain embodiments, waste-recovered fuel utilized by the system contains an amount of water which promotes self-cleaning of certain fuel lines or fuel passageways within the system. In various embodiments, fuel-laden waste is unfiltered and not treated to remove water before it is deposited in the cogeneration system.

Types of fuel-laden waste that can be utilized to produce heat and power by the cogeneration system include vegetable oil that has been utilized in food preparation, lard that has been utilized in food preparation, hydrogenated oil that has been utilized in food preparation, and any combination thereof. Additional types of fuel-laden waste that can be utilized by the cogeneration system include a petroleum product that has been utilized in a machine application selected from the following group: engine lubrication, transmission lubrication, hydraulic power transmission, hydraulic lines, power steering, machine cutting (e.g., cutting oils), and any combination thereof. Additional types of fuel-laden waste that can be utilized by the cogeneration system include a synthetic product that has been utilized in a machine application selected from the following group: engine lubrication, transmission lubrication, hydraulic power transmission, hydraulic lines, power steering, machine cutting, and any combination thereof. In some embodiments, fuel-laden waste utilized by the system comprises virgin vegetable oil, virgin lard, virgin hydrogenated oil, biodiesel, petroleum diesel or any combination thereof. In some embodiments, the cogeneration system's engine 111 can combust gases such as propane, natural gas, hydrogen, carbon monoxide, methane, or any combination thereof.

### Secondary Fuel Sources

In certain embodiments, the cogeneration system utilizes secondary fuel sources 204 during operation. The secondary fuel can be contaminated with a solvent or an emulsion. In some embodiments, secondary fuels are harvested from municipal sewerage waste streams. As an example, secondary fuel source apparatus 204 can comprise a connection to a grease trap, e.g., a settling basin, to capture and harvest organic compounds for combustion in the cogeneration system.

In some embodiments, hydrocarbons from secondary sources are introduced to the intake tank 112 or heat exchanger 318 where they intermix with other waste-recovered fuels. With the ability to remove large amounts of water contamination, opportunistic fuels from a secondary fuel source can be introduced and processed by the cogeneration system. The introduction of secondary fuels can occur once the thermal parameters of the system have reached a desired operating level. Secondary fuels such as animal fats, natural or industrial waxes, paraffins, used lubricating oils, and the like, being contaminated with water or other materials and unfit for other use, can be introduced, combined, and processed within the inventive cogeneration system along with a primary source or raw fuel-laden waste.

### Solids Processing

The inventive cogeneration system can be adapted to process solid fuel-laden waste. In certain embodiments, high-temperature combustion products from the system's engine first pass through a solids processor 123. The solids processor 123 can be located on or in close proximity to the internal combustion engine 111. Heat provided by the high-temperature combustion products can be utilized in the solids processor 123 to convert organic solids to combustible gasses via gasification or pyrolysis. These combustible gasses can then be provided to the internal combustion engine 111 for combustion and energy harvesting. Residual heat in the engine combustion products after their passing through the solids processor 123 can be utilized to heat waste-recovered fuel in the intake tank 112 or fuel heat exchanger 318.

### Automated Control

In certain embodiments, the cogeneration system 100 includes control apparatus adapted to prevent an over-temperature condition of the waste-recovered fuel in the intake fuel tank 112, the heat exchanger 318, or the secondary tank 113. This can prevent the fuel from reaching a temperature at which it will begin to rapidly degrade, e.g., form non-combustible polymers, or spontaneously ignite. One embodiment of such control is an exhaust control valve 305 linked to a thermostat or temperature sensing control system. When a monitored temperature of the waste-recovered fuel exceeds a selected value, the control valve is operated to reduce the amount of exhaust flow through the fuel-warming system 210. In some embodiments, a bypass restriction or orifice placed in the fuel-warming system or bypass loop controls the amount of exhaust flowing through the bypass and controls the maximum or steady-state temperature of the waste-recovered fuel. In some embodiments, the use of an orifice eliminates the need for an active control system to regulate the temperature of the waste-recovered fuel.

In some embodiments, introduction of secondary fuel into the cogeneration system is automated. As an example, the secondary fuel can be automatically metered, e.g., using control valve 205, into the intake tank 112 or heat exchanger 318 to regulate the temperature of waste-recovered fuel therein. When secondary fuels highly contaminated with water are introduced to the system, the water within the secondary fuel can be vaporized which removes thermal energy from the primary bulk of waste-recovered fuel. This can also create a large amount of oil spatter which is contained by the enclosed tank or exchanger design. The explosive vaporization can assist in cleaning tank or exchanger components. The vaporized water can be vented from the tank or exchanger, thereby also removing water from the secondary and primary waste-recovered fuels. As the fuel temperature reduces, the introduction of secondary fuel can be proportionally reduced.

In certain embodiments, the flow of cooling fluid in thermal exchange circuit 240 is controlled by a system processor 250 to automate temperature regulation of waste-recovered fuel. In some embodiments, the combustion cycle in the engine 111 is controlled by a system processor 250 to maintain a desired temperature of waste-recovered fuel. For example, the engine may slow down to reduce heat provided to the fuel-warming system 210.

In some embodiments, automated control apparatus is provided with the cogeneration system to start and run the engine periodically during periods when the ambient temperature is less than about 20° F. This can maintain engine components and waste-recovered fuel at elevated temperatures to promote starting of the system during cold periods. In some embodiments, automated control apparatus is provided with the system to start the engine after receiving an amount of waste-recovered fuel that exceeds a first threshold value and stop the engine when the amount of waste-recovered fuel within the system's intake tank 112 or intake receptacle 203 falls below a second threshold value. This can prevent fuel lines or tanks in the system from running dry.

In certain embodiments, automated control apparatus is provided with the cogeneration system to deactivate the system during noise-sensitive hours, and reactivate the system at the expiration of noise-sensitive hours.

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, described techniques, or the like, this application controls.

The section headings used herein are for organizational purposes only and are not to be construed as limiting the subject matter described in any way.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. A cogeneration system comprising:
an internal combustion engine;
an electrical generator powered by the internal combustion engine, the electrical generator adapted to provide electrical power external to the cogeneration system;
an excess thermal energy system adapted to extract thermal energy produced by the internal combustion engine and provide excess thermal energy external to the cogeneration system; and
a fuel-warming system adapted to extract thermal energy from engine combustion products and provide thermal energy to heat waste-recovered fuel within the cogeneration system so that water within the heated waste-recovered fuel is vaporized and separated from the fuel.

2. The cogeneration system of claim 1 adapted to receive and prepare raw fuel-laden waste for combustion in the engine wherein the fuel-laden waste has not been pre-filtered or pre-treated to remove particulates or water.

3. The cogeneration system of claim 2, wherein the fuel-laden waste comprises vegetable oil that has been utilized in food preparation.

4. The cogeneration system of claim 2, wherein the fuel-laden waste comprises fat that has been utilized in food preparation.

5. The cogeneration system of claim 2, wherein the fuel-laden waste comprises hydrogenated oil that has been utilized in food preparation.

6. The cogeneration system of claim 2, wherein the fuel-laden waste comprises a petroleum product that has been utilized in a machine application selected from the following group: engine lubrication, transmission lubrication, hydraulic power transmission, hydraulic lines, power steering, and machine cutting.

7. The cogeneration system of claim 2, wherein the fuel-laden waste comprises a synthetic product that has been utilized in a machine application selected from the following group: engine lubrication, transmission lubrication, hydraulic power transmission, hydraulic lines, power steering, and machine cutting.

8. The cogeneration system of claim 1, further comprising:
an intake receptacle having a coarse filter; and
an intake tank wherein the receptacle and tank comprise a dumpster for fuel-laden waste.

9. The cogeneration system of claim 8, wherein waste-recovered fuel within the intake tank is in thermal communication with the fuel-warming system.

10. The cogeneration system of claim 8, wherein the intake tank is connected to a grease trap.

11. The cogeneration system of claim 8, wherein the intake receptacle receives waste fry oil directly from a fryer.

12. The cogeneration system of claim 1, wherein the internal combustion engine is a diesel engine.

13. The cogeneration system of claim 1, wherein the electrical generator provides electrical power to a facility.

14. The cogeneration system of claim 13, wherein the facility comprises a commercial business, a residential dwelling, a maritime vessel, a train, a storage facility, an industrial facility, a warehouse, a mobile dwelling, or a camp.

15. The cogeneration system of claim 1, wherein the electrical generator provides electrical power to a local electrical power distribution grid.

16. The cogeneration system of claim 1, further comprising an inverter providing interconnection to a local electrical power distribution grid.

17. The cogeneration system of claim 1, wherein the electrical generator comprises a synchronous generator or inductive generator adapted to provide interconnection to a local electrical power distribution grid.

18. The cogeneration system of claim 1, wherein the electrical generator provides electrical current to an electrical storage device.

19. The cogeneration system of claim 1, wherein the internal combustion engine provides power to the drive train of a vehicle.

20. The cogeneration system of claim 19, wherein the vehicle comprises a hybrid diesel/electric vehicle.

21. The cogeneration system of claim 1, wherein the excess thermal energy is used to heat domestic hot water.

22. The cogeneration system of claim 1, wherein the excess thermal energy is used to heat air in a building.

23. The cogeneration system of claim 1, further comprising a fuel heat exchanger in communication with or integrated with the fuel-warming system, wherein the fuel heat exchanger provides self-cleaning of waste-recovered fuel polymers from within the fuel heat exchanger.

24. The cogeneration system of claim 23, wherein the fuel heat exchanger is operated under pressure.

25. The cogeneration system of claim 23, wherein the fuel heat exchanger is operated under reduced pressure to promote water removal at temperatures less than about 212° F.

26. The cogeneration system of claim 23, wherein the fuel heat exchanger is operated at a temperature and pressure such that long chain waxes within the fuel pass through a fine fuel filter disposed in a fuel line running from the fuel heat exchanger.

27. The cogeneration system of claim 23, wherein the fuel heat exchanger provides direct thermal communication between an amount of flowing waste-recovered fuel and at least a portion of the fuel-warming system.

28. The cogeneration system of claim 27, wherein the residence time of the amount of waste-recovered fuel flowing through the fuel heat exchanger is controlled such that water within the amount of fuel boils.

29. The cogeneration system of claim 27, wherein the amount of waste-recovered fuel within the heat exchanger reaches a temperature between about 212° F. and about 275° F.

30. The cogeneration system of claim 27, further comprising an exhaust bypass adapted to divert engine exhaust around the fuel heat exchanger and maintain the temperature of waste-recovered fuel exiting the heat exchanger between about 212° F. and about 275° F.

31. The cogeneration system of claim 1, further comprising a secondary fuel tank adapted to heat waste-recovered fuel within the tank by a secondary source of energy other than thermal energy from engine combustion products.

32. The cogeneration system of claim 31, wherein the secondary fuel tank is disposed between an intake tank or fuel heat exchanger and the internal combustion engine.

33. The cogeneration system of claim 31, wherein the secondary source of energy comprises electricity, microwaves, solar radiation, or any combination thereof.

34. The cogeneration system of claim 31, wherein the secondary fuel tank is further adapted to provide heated fuel to the internal combustion engine for combustion.

35. The cogeneration system of claim 31, wherein the secondary fuel tank is further adapted to provide heated fuel to a fluid circulation circuit disposed with the internal combustion engine.

36. The cogeneration system of claim 35, wherein the fluid circulation circuit elevates the temperature of an engine component to promote combustion of the waste-recovered fuel.

37. The cogeneration system of claim 35, wherein the fluid circulation circuit provides heat to the engine block of the internal combustion engine, to high-pressure fuel lines running to cylinders in the engine, to a fuel pump which provides fuel to the engine's cylinders, or any combination thereof.

38. The cogeneration system of claim 1, wherein the waste-recovered fuel comprises virgin vegetable oil, virgin lard, virgin hydrogenated oil, biodiesel, petroleum diesel or any combination thereof.

39. The cogeneration system of claim 1, wherein the waste-recovered fuel comprises propane, natural gas, hydrogen, carbon monoxide, methane, or any combination thereof.

40. The cogeneration system of claim 1, further comprising a solids processing unit adapted to transform waste organic solids into a fuel which is combustible by the internal combustion engine.

41. The cogeneration system of claim 40, wherein the solids processing unit utilizes thermal energy from engine combustion products.

42. The cogeneration system of claim 40, wherein the organic solids are transformed by gassification or pyrolysis.

43. The cogeneration system of claim 1, further comprising a solids processing unit adapted to utilize thermal energy from engine combustion products to transform waste organic solids into liquid organic compounds.

44. The cogeneration system of claim 1, further comprising automated control apparatus adapted to start and run the engine periodically during periods when the ambient temperature is less than about 20° F.

45. The cogeneration system of claim 1, further comprising automated control apparatus adapted to start the engine after receiving an amount of waste-recovered fuel that exceeds a first threshold value and stop the engine when the amount of waste-recovered fuel falls below a second threshold value.

46. The cogeneration system of claim 1, further comprising automated control apparatus adapted to deactivate the system during noise-sensitive hours, and reactivate the system at the expiration of noise-sensitive hours.

47. The cogeneration system of claim 1, wherein the system is sized to substantially match its fuel consumption rate to the rate of generation of fuel-laden waste by the source of fuel-laden waste over a selected period of time.
